(19) United States
(12) Patent Application Publication
(10) Pub. No.: US 2011/0304779 A1
(43) Pub. Date: Dec. 15, 2011

(54) Electronic Apparatus and Image Processing Method

(76) Inventors: Kouetsu Wada, Nishitama-gun (JP); Kohei Momosaki, Mitaka-shi (JP); Kenichi Tabe, Ome-shi (JP); Tomonori Sakaguchi, Ome-shi (JP)

(21) Appl. No.: 13/047,570

(22) Filed: Mar. 14, 2011

(30) Foreign Application Priority Data
Jun. 15, 2010 (JP) 2010-136533

(51) Int. Cl. H04N 5/66

(52) U.S. Cl. 348/739

(57) ABSTRACT

According to one embodiment, an electronic apparatus includes an indexing module, an image select module, an image extraction module, and an image display module. The indexing module generates index information of a plurality of still images. The image select module selects a still image from the plurality of still images. The image extraction module extracts still images which are relevant to the selected still image from the plurality of still images by using the index information. The image display module displays a moving picture using the extracted still images.

### CROSS-REFERENCE TO RELATED APPLICATIONS

This application is based upon and claims the benefit of priority from Japanese Patent Application No. 2010-136533, filed Jun. 15, 2010; the entire contents of which are incorporated herein by reference.

### FIELD

Embodiments described herein relate generally to an electronic apparatus which displays an image, and an image processing method which is applied to the electronic apparatus.

### BACKGROUND

In recent years, various electronic apparatuses, such as a personal computer, a digital camera and a PDA, have been gaining in popularity. Such an electronic apparatus has a function of managing still images such as photos. As an image management method, there is known a method of classifying photos into groups, based on taken position data (e.g. latitude/longitude) which is added to the photos.

In addition, recently, attention has been paid to a moving picture creation technique for creating a moving picture (e.g. photomovie, slideshow, etc.) by using still images such as photos. As the moving picture creation technique, for example, there is known a technique wherein still images are stored directories corresponding to taken positions (areas) by classifying the still images based on their taken positions, and a moving picture is created by using still images in a directory designated by a user.

In the method in which the user designates the directory which is a process target, however, the still images which are to be displayed are limited to the still images in the designated directory. It is thus difficult to present to the user a moving picture including unexpected still images (still images of which the user is unaware) and still images which are not stored in the same directory but have high relevance.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the external appearance of an electronic apparatus according to an embodiment.

FIG. 2 is an exemplary block diagram showing the system configuration of the electronic apparatus of the embodiment.

FIG. 3 is an exemplary block diagram showing the functional structure of a moving picture creation application program which is executed by the electronic apparatus of the embodiment.

FIG. 4 shows an example of index information which is used by the moving picture creation application program which is executed by the electronic apparatus of the embodiment.

FIG. 5 is an exemplary conceptual view showing an example of a photomovie creation process which is executed by the electronic apparatus of the embodiment.

FIG. 6 shows an example of a main screen which is displayed by the electronic apparatus of the embodiment.

FIG. 7 shows an example of a key image select screen which is displayed by the electronic apparatus of the embodiment.

FIG. 8 shows an example of a calendar screen which is displayed by the electronic apparatus of the embodiment.

FIG. 9 shows an example of a photomovie including a face image to which an effect has been applied, the photomovie being displayed by the electronic apparatus of the embodiment.

FIG. 10 shows an example of a photomovie including a still image to which an effect has been applied, the photomovie being displayed by the electronic apparatus of the embodiment.

FIG. 11 shows an example of a photomovie including a still image and a face image, to which an effect has been applied, the photomovie being displayed by the electronic apparatus of the embodiment.

FIG. 12 is an exemplary flowchart illustrating an example of the procedure of an indexing process which is executed by the electronic apparatus of the embodiment.

FIG. 13 is an exemplary flowchart illustrating an example of the procedure of a moving picture generation process which is executed by the electronic apparatus of the embodiment.

FIG. 14 is an exemplary flowchart illustrating an example of the procedure of a key image select process which is executed by the electronic apparatus of the embodiment.

FIG. 15 is an exemplary flowchart illustrating another example of the procedure of the key image select process which is executed by the electronic apparatus of the embodiment.

FIG. 16 is an exemplary flowchart illustrating an example of the procedure of a relevant image select process which is executed by the electronic apparatus of the embodiment.

### DETAILED DESCRIPTION

Various embodiments will be described hereinafter with reference to the accompanying drawings.

In general, according to one embodiment, an electronic apparatus includes an indexing module, an image select module, an image extraction module, and an image display module. The indexing module generates index information of a plurality of still images. The image select module selects a still image from the plurality of still images. The image extraction module extracts still images which are relevant to the selected still image from the plurality of still images by using the index information. The image display module displays a moving picture using the extracted still images.

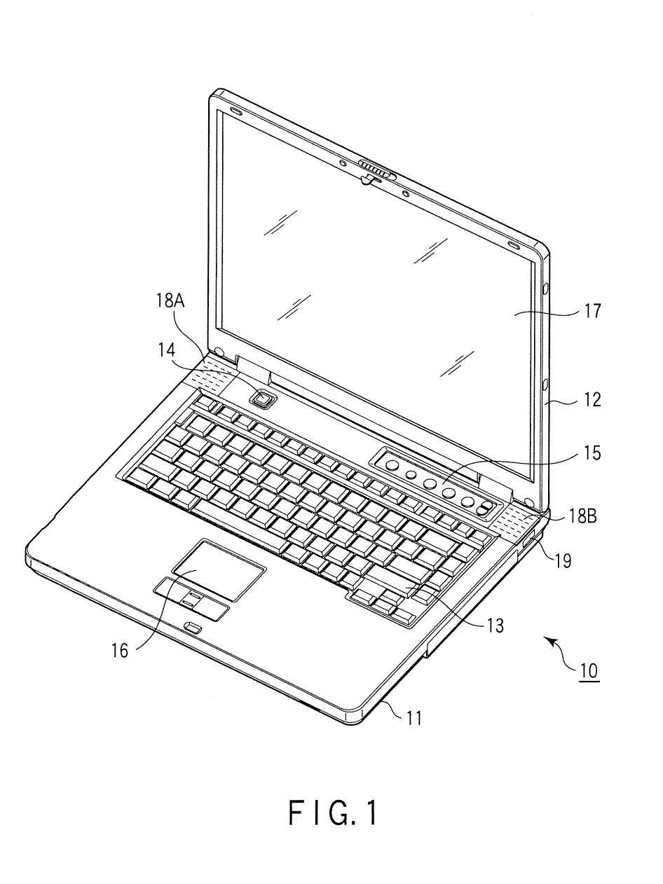

FIG. 1 is a perspective view showing the external appearance of an electronic apparatus according to an embodiment. The electronic apparatus is realized, for example, as a notebook-type personal computer 10. As shown in FIG. 1, the computer 10 includes a computer main body 11 and a display unit 12. A liquid crystal display (LCD) 17 is built in the display unit 12. The display unit 12 is attached to the computer main body 11 such that the display unit 12 is rotatable between an open position where the top surface of the computer main body 11 is exposed, and a closed position where the top surface of the computer main body 11 is covered.

The computer main body 11 has a thin box-shaped housing. A keyboard 13, a power button 14 for powering on/off the computer 10, an input operation panel 15, a touchpad 16, and speakers 18A and 18B are disposed on the top surface of the housing of the computer main body 11. Various operation buttons are provided on the input operation panel 15.

The right side surface of the computer main body 11 is provided with a USB connector 19 for connection to a USB cable or a USB device of, e.g. the universal serial bus (USB) 2.0 standard.

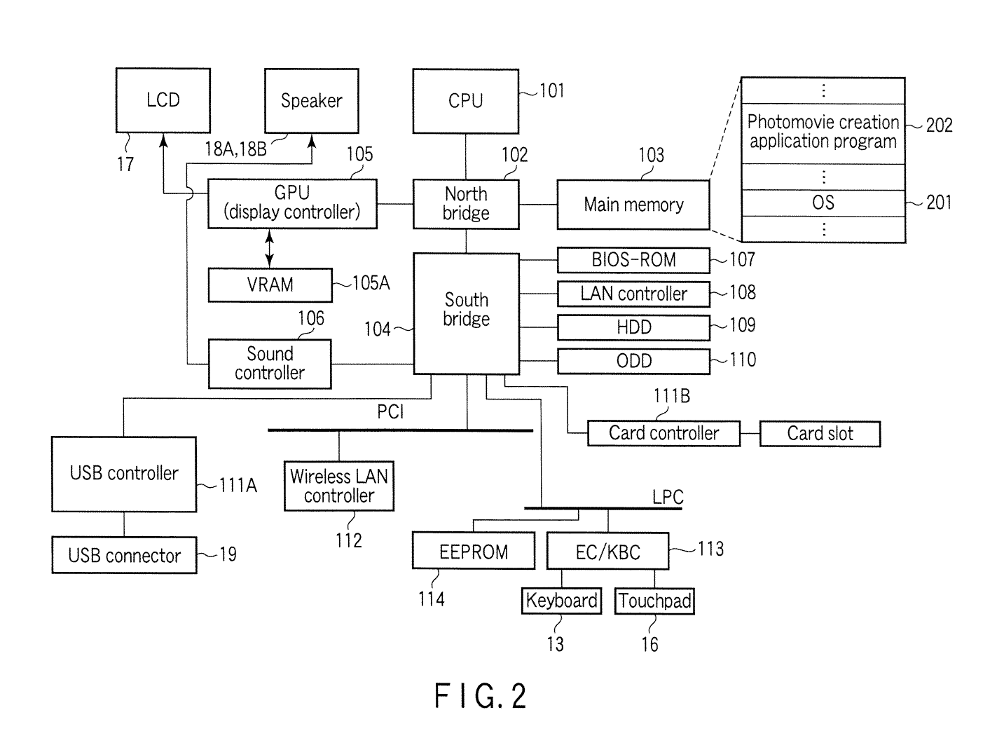

FIG. 2 shows the system configuration of the computer 10.

The computer 10, as shown in FIG. 2, includes a central processing unit (CPU) 101, a north bridge 102, a main memory 103, a south bridge 104, a graphics processing unit (GPU) 105, a video random access memory (VRAM) 105A, a sound controller 106, a basic input/output system-read only memory (BIOS-ROM) 107, a local area network (LAN) controller 108, a hard disk drive (HDD) 109, an optical disc drive (ODD) 110, a USB controller 111A, a card controller 111B, a wireless LAN controller 112, an embedded controller/keyboard controller (EC/KBC) 113, and an electrically erasable programmable ROM (EEPROM) 114.

The CPU 101 is a processor for controlling the operations of the respective components in the computer 10. The CPU 101 executes an operating system (OS) 201 and various application programs, such as a photomovie creation application program 202, which are loaded from the HDD 109 into the main memory 103. The photomovie creation application program 202 is software which plays back various digital content data (e.g. photomovie) which are stored in, e.g. the HDD 109. The photomovie creation application program 202 has a moving picture generation function. The moving picture generation function is a function of creating a composite moving picture (movie) by using contents (digital contents) such as digital photos stored in, e.g. the HDD 109. Further, the moving picture generation function includes a function of analyzing the contents which are used for the moving picture. The photomovie creation application program 202 plays back the moving picture which is created by using the contents, and displays the moving picture on the screen (LCD 17).

The CPU 101 executes a BIOS that is stored in the BIOS-ROM 107. The BIOS is a program for hardware control.

The north bridge 102 is a bridge device which connects a local bus of the CPU 101 and the south bridge 104. The north bridge 102 includes a memory controller which access-controls the main memory 103. The north bridge 102 also has a function of communicating with the GPU 105 via, e.g. a PCI EXPRESS serial bus.

The GPU 105 is a display controller which controls the LCD 17 that is used as a display monitor of the computer 10. A display signal, which is generated by the GPU 105, is sent to the LCD 17.

The south bridge 104 controls devices on a peripheral component interconnect (PCI) bus and devices on a low pin count (LPC) bus. The south bridge 104 includes an integrated drive electronics (IDE) controller for controlling the HDD 109 and ODD 110. The south bridge 104 also has a function of communicating with the sound controller 106.

The sound controller 106 is a sound source device and outputs audio data, which is a playback target, to the speakers 18A and 18B. The LAN controller 108 is a wired communication device which executes wired communication of, e.g. the IEEE 802.3 standard. On the other hand, the wireless LAN controller 112 is a wireless communication device which executes wireless communication of, e.g. the IEEE 802.11g standard. The USB controller 111A executes communication with an external device which supports, e.g. the USB 2.0 standard (the external device is connected via the USB connector 19). For example, the USB controller 111A is used in order to receive an image data file which is stored in, for example, a digital camera. The card controller 111B executes data write and data read in/from a memory card such as an SD card, which is inserted in a card slot provided in the computer main body 11.

The EC/KBC 113 is a one-chip microcomputer in which an embedded controller for power management and a keyboard controller for controlling the keyboard 13 and touchpad 16 are integrated. The EC/KBC 113 has a function of powering on/off the computer 10 in accordance with the user's operation of the power button 14.

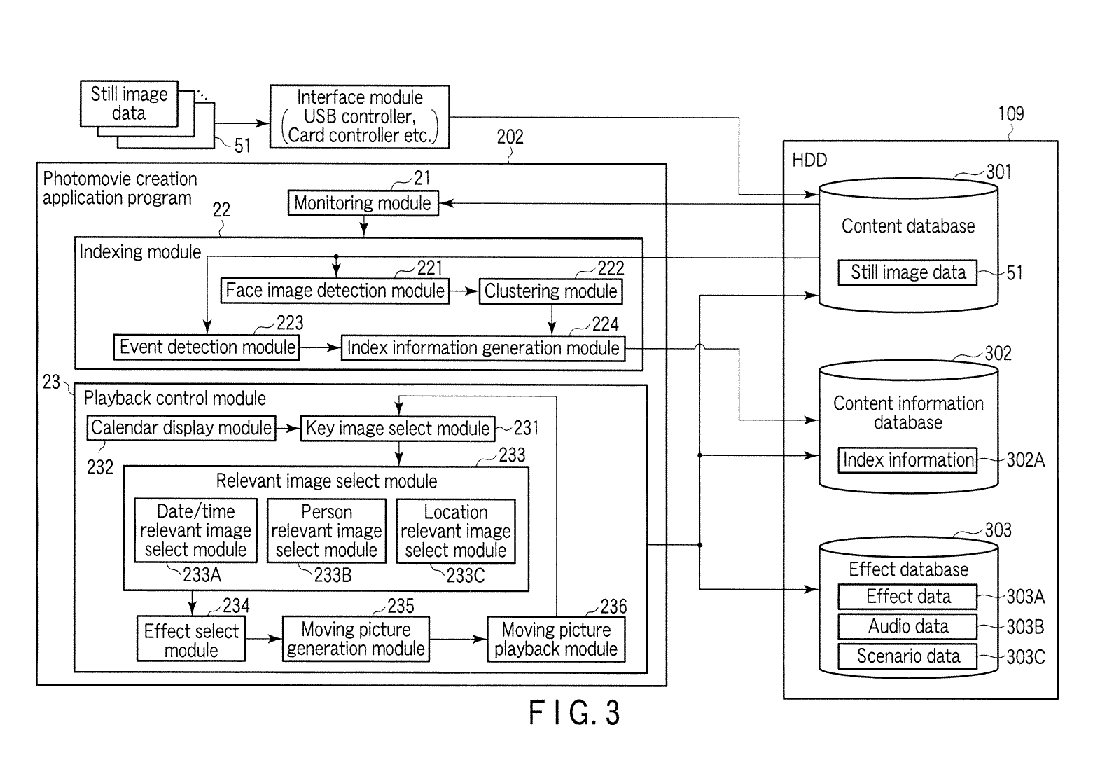

Next, referring to FIG. 3, a functional structure of the photomovie creation application program 202 is described. A description is given of a structure example for realizing a moving picture generation function, which is one of the functions of the photomovie creation application program 202. The moving picture generation function is a function for creating a moving picture (e.g. photomovie or slideshow) by using still images (still image data) 51 stored in a predetermined directory (content database 301) in the HDD 109, and playing back the created moving picture. The still images 51 are, for instance, digital photos, or other various still image files (JPEG files). The term “photomovie” refers to a moving picture (movie) which is generated by using still images (e.g. photos). In the playback of the photomovie, various effects or transitions are applied to the still images. The still images, to which the effects or transitions have been applied, are played back together with music. The photomovie creation application program 202 can automatically extract still images which are relevant to a certain still image (key image), and can create and play back the photomovie by using the extracted still images. In addition, the photomovie creation application program 202 can create and play back a slideshow by using the extracted still images. The term “slideshow” refers to a moving picture (movie) which successively displays the still images one by one. The photomovie is also referred to as an intelligent slide show.

The photomovie creation application program 202 monitors the folder (photo folder) in the HDD 109, which is set by the user. When the photomovie creation application program 202 detects that one or more new still images (photo files) have been stored in the photo folder, the photomovie creation application program 202 executes indexing of the one or more new still images and, at the same time, starts a slideshow of the one or more new still images. If the indexing is completed, the photomovie creation application program 202 creates a photomovie based on the one or more new still images, and plays back the created photomovie. In this case, for example, a photomovie may be created from only the one or more new still images, and the created photomovie may be played back. Alternatively, still images relevant to the one or more new still images may be extracted from the still images in the photo folder, a photomovie may be created by using the one or more new still images and the extracted still images, and the photomovie may be played back.

The creation of the photomovie is executed based on one still image (key image). Specifically, still images relevant to a selected key image are automatically extracted, and a photomovie is created by using the extracted still images. Each of a style, a music and a person (face) of interest can be designated as a condition for creating a photomovie. According to the selected style, method for extracting still images to be used and an effect/transition (effects/transitions) to be used are determined. In the prior art, photos which are used in creating a movie are designated by the user. On the other hand, the photomovie creation application program 202 automatically extracts photos, which are to be used, from all still images in the photo folder. Thereby, unexpected photos can be found and shown to the user.

In the extraction process, photos with better photographic quality may be extracted according to the smile degree of face images, the sharpness of face images, etc. In addition, for example, photos including face images of the selected person, or photos including face images of another person who has relevance to the selected person may be extracted by recognizing a person corresponding to each face image by face clustering. Furthermore, photos may be classified into a plurality of events by using an event grouping technique. In this case, the relevance between events may be estimated based on the relationship between appearing persons in a certain event and appearing persons in another event, and the result of estimation may be used in the extraction process. For example, events in which the same person appears may be estimated to be relevant. For example, if the frequency (co-occurrence frequency), with which a person A and another person B appear in the same photo, is high, it may be estimated that an event, to which a photo including the person A belongs, is relevant to an event to which a photo including the person B belongs.

The photomovie creation application program 202 includes a monitoring module 21, an indexing module 22 and a playback control module 23.

The monitoring module 21 determines whether a new still image 51 has been stored in the content database 301 via an interface module such as the USB controller 111A or card controller 111B by monitoring the content database 301 in the HDD 109. The content database 301 corresponds to a predetermined directory (the above-described photo folder) in the HDD 109. The still image 51 stored in the content database 301 is used as a content candidate of a composite moving picture (photomovie or slideshow). Not only the still images 51, but also a moving picture, such as a short movie, may be stored as a content candidate. The monitoring module 21 notifies the indexing module 22 that the new still image 51 has been stored in the HDD 109.

Responding to the notification from the monitoring module 21, the indexing module 22 generates index information 302A indicative of attributes of each of the still images 51 in the content database 301 by analyzing the still images 51. The indexing by the indexing module 22 is started, for example, triggered by the storage of one or more new still images (photo files) in the content database 301. In other words, when one or more new still images have been stored in the content database 301, the indexing module 22 generates the index information 302A corresponding to the new still image(s).

The indexing module 22 has a face recognition function. The index information 302A also includes a recognition result of face images included in the still images 51.

The indexing module 22 includes a face image detection module 221, a clustering module 222, an event detection module 223, and an index information generation module 224.

The face image detection module 221 detects a face image from the still image 51 that is a target of indexing (e.g. a still image newly stored in the photo folder). The face image can be detected, for example, by analyzing the features of the still image 51 and searching for a region having a feature similar to a face image feature sample which is prepared in advance. The face image feature sample is characteristic data which is obtained by statistically processing face image features of many persons. By the face detection process, the region corresponding to the face image included in the still image 51 is detected. Specifically the position (coordinates) and size of the region are detected.

In addition, the face image detection module 221 analyzes the detected face image. The face image detection module 221 calculates, for example, the smile degree, sharpness, frontality, etc. of the detected face image. The smile degree is an index indicative of the degree of a smile of the detected face image. The sharpness is an index indicative of the degree of sharpness of the detected face image (e.g. non-blurredness). The frontality is an index indicative of the degree at which the detected face image is directed to the front side.

The face image detection module 221 outputs the information indicative of the detected face image to the clustering module 222.

The clustering module 222 classifies the detected face image on a person-by-person basis by subjecting the detected face image to a clustering process. Based on the processing result, the clustering module 222 allocates identification information (person ID) of the person corresponding to the face image. The clustering module 222 outputs the information indicative of the face image and the information indicative of the attributes of the face image (the smile degree, sharpness, frontality, person ID) to the index information generation module 224.

The event detection module 223 detects an event corresponding to the still image 51 which is an indexing target. The event detection module 223 classifies, for example, still images 51, which are generated within a predetermined period (e.g. one day), into the same event, based on the date and time of generation (date and time of imaging) of the still image 51 of the indexing target. In addition, based on the dates and times of generation of still images 51, when a difference (an interval of generation) between the dates and times of generation of still images 51, which neighbor in a time sequence, is within a predetermined time, the event detection module 223 classifies these neighboring still images 51 into the same event. The event detection module 223 allocates to the still images 51 the identification information (event ID) of the event to which the still images 51 have been classified. The event detection module 223 outputs the event ID, which has been allocated to the still images 51, to the index information generation module 224.

The index information generation module 224 generates the index information 302A, based on the processing results by the face image detection module 221, clustering module 222 and event detection module 223.

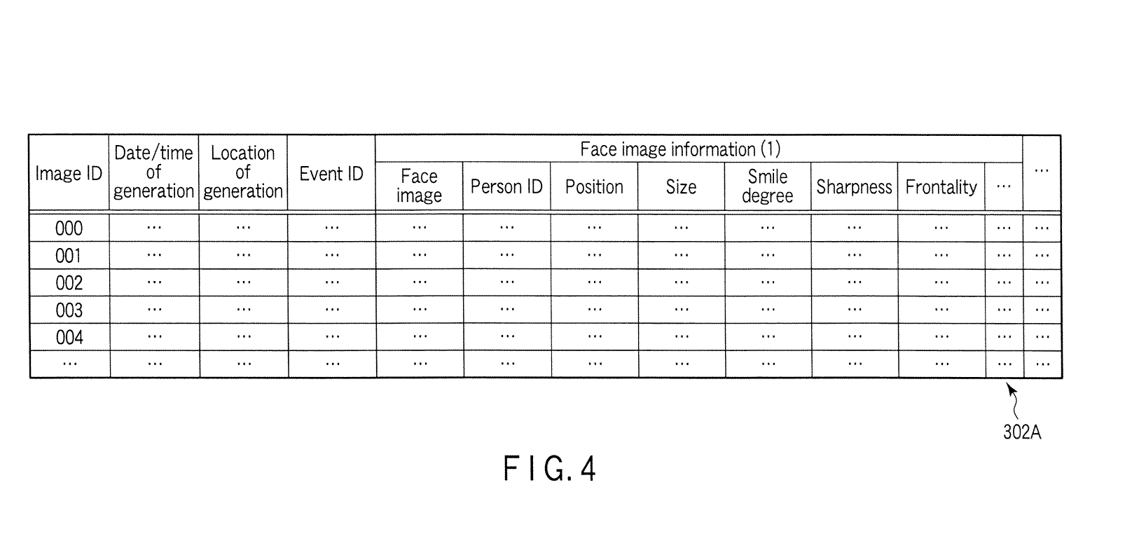

FIG. 4 shows a structure example of the index information 302A. The index information 302A includes a plurality of entries corresponding to the still images 51. Each entry includes an image ID, a date and time of generation (date and time of imaging), a location of generation (location of imaging), an event ID, and face image information. In the entry corresponding to a certain image, the image ID is indicative of identification information which is unique to the still image. The date and time of generation (date and time of imaging) is indicative of the date and time at which the still image was generated. The location of generation is indicative of the location (position) where the still image was generated (captured). For example, information, which is added to the image data, is used for the date and time of generation and the location of generation. The location of generation is indicative of, for example, position information which is detected by a GPS receiver when the still image 51 is generated (e.g. when the photo corresponding to the still image 51 is taken). The event ID is indicative of identification information which is uniquely allocated to the event corresponding to the still image 51. The face image information includes, for example, a face image (e.g. the location of storage of data corresponding to the face image), person ID, position, size, smile degree, sharpness, and frontality. When the still image 51 includes a plurality of face images, the index information 302A includes face image information corresponding to each of the face images.

The index information generation module 224 stores the generated index information 302A in the content information database 302.

By the above-described structure, the indexing module 22 can generate the index information 302A corresponding to the still image 51 of the indexing target, and can store the generated index information 302A in the content information database 302.

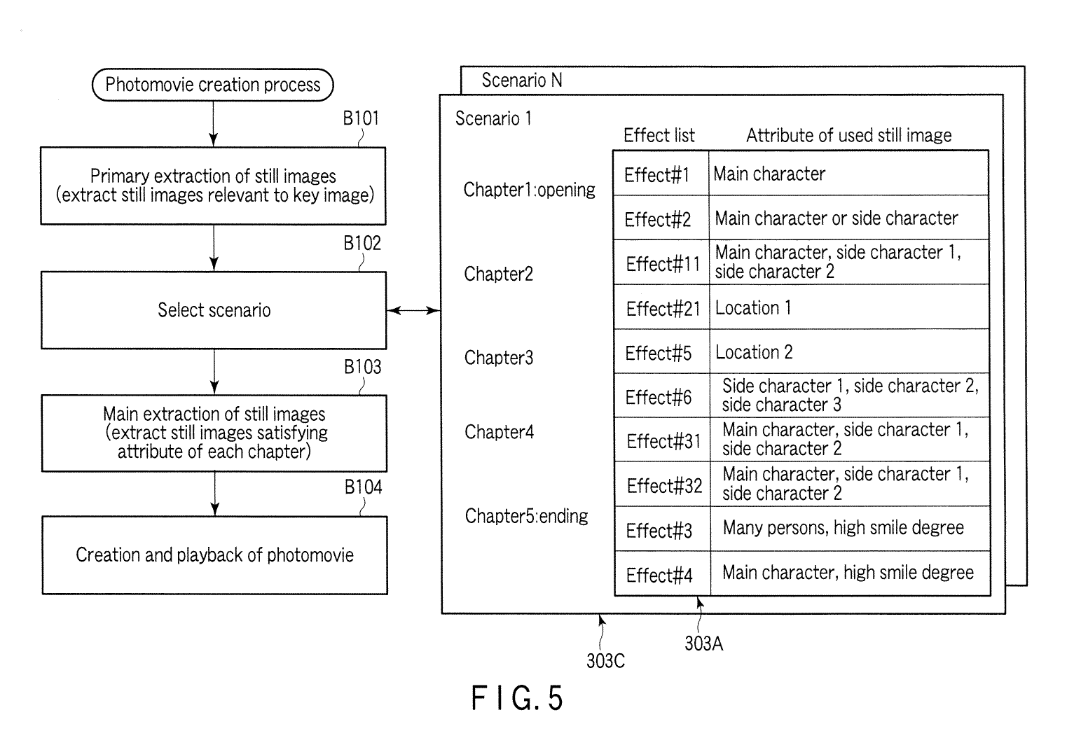

The playback control module 23 generates a moving picture (photomovie or slideshow) using still images 51, by making use of the index information 302A generated by the indexing module 22 (indexing information generation module 223). The playback control module 23 extracts still images which are relevant to a selected still image (key image) from the still images 51 in the content database 301, based on the index information 302A. The playback control module 23 creates and plays back a photomovie or slideshow by using the relevant still images. The playback control module 23 includes, for example, a key image select module 231, a calendar display module 232, a relevant image select module 233, an effect select module 234, a moving picture generation module 235, and a moving picture playback module 236. FIG. 5 illustrates the outline of photomovie creation by the playback control module 23.

To start with, the relevant image select module 233 extracts (primary extraction) still images 51, which are relevant to a key image, from the content database 301 (block B101). The key image is selected by the key image select module 231 and is used as an extraction key for extracting still images 51 from the content database 301.

Then, the effect select module 234 selects scenario data 303C which is used for a photomovie (block B102). The scenario data 303C includes a plurality of chapters (scenes). Each of the chapters is associated with at least one effect (effect data) 303A. In the effect 303A, an attribute of the image 51, to which the effect is applied, is prescribed. For example, in a first effect 303A (Effect #1), it is prescribed that the effect is applied to a face image of a main character.

Subsequently, the moving picture generation module 235 further extracts (main extraction) still images 51, which are suited to the selected scenario data 303C, from the still images 51 which have been extracted (primary extraction) in block B101 (block B103). The moving picture generation module 235 extracts still images 51 in accordance with the attribute of each chapter (effect 303A). The moving picture generation module 235 creates a photomovie by using the scenario data 303C which is selected in block B102, and the still images 51 which are extracted in block B103, and the moving picture playback module 236 plays back the created photomovie (block B104).

By the above-described process, the playback control module 23 can create the photomovie by using the still images 51 stored in the content database 301. Similarly, the playback control module 23 can create a slideshow by using the still images 51 stored in the content database 301. In the slideshow, the extracted still images 51 are successively displayed, and no effect is applied to the still images 51. In the slideshow, a transition effect may be applied when the still images 51 are changed.

Next, the operations of the respective components in the playback control module 23 are described in detail.

The key image select module 231 selects a key image (key still image) from still images (still image data) stored in the content database 301. The key image is used as an extraction key for extracting still images 51, which are used for a moving picture (photomovie or slideshow), from the content database 301.

The key image select module 231 determines an image, which is designated by the user, for example, on the moving picture displayed on the screen (LCD 17), to be the key image. The moving picture displayed on the screen is, for instance, a photomovie or a slideshow, which is generated by the photomovie creation application 202. Specifically, the key image select module 231 determines an image, which is designated by the user when the generated photomovie or slideshow is played back, to be the key image. If no image is designated by the user when the generated photomovie or slideshow is played back, the key image select module 231 may determine the last still image, which is included in the played-back photomovie or slideshow, to be the key image.

The key image select module 231 may select a key image by using a calendar screen in which still images 51 are arranged on a calendar. The key image select module 231 determines, for example, the still image 51, which is designated by the user with use of the calendar screen, to be the key image.

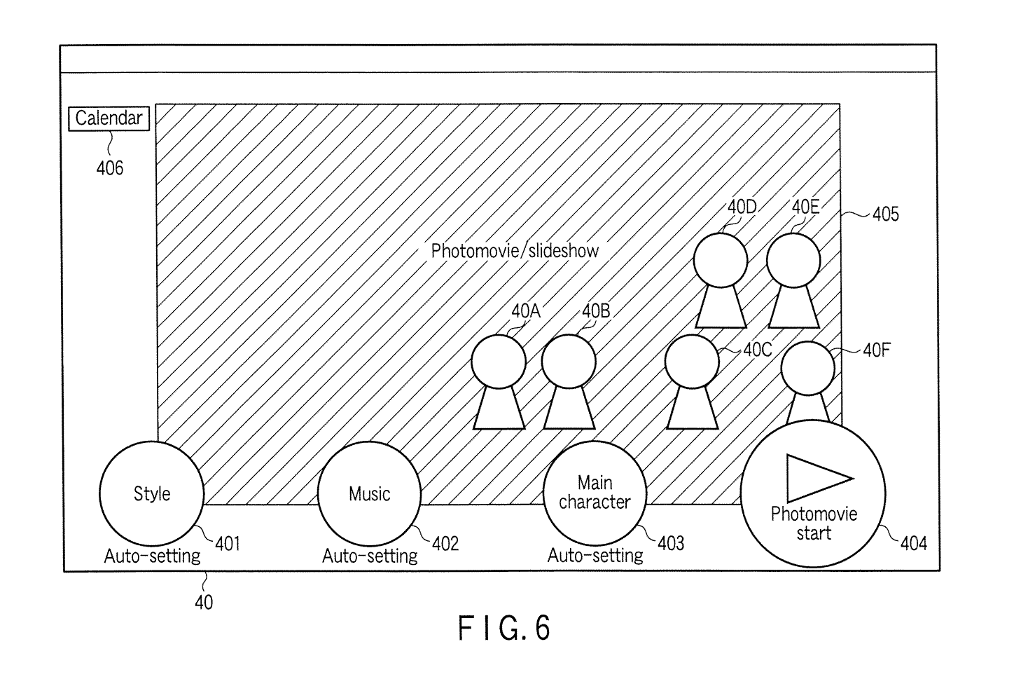

Further, the key image select module 231 selects a face image of a person of interest from face images included in the determined key image, and then determines the selected face image to be a key face image. The details of the selection of the key image and key face image will be described later with reference to FIGS. 6, 7 and 8. The key image select module 231 outputs the information indicative of the determined key image and key face image to the relevant image select module 233.

The relevant image select module 233 selects, from the still images 51 stored in the content database 301, still images 51 which are relevant to the key image (key face image) selected by the key image select module 231. The still image 51 relevant to the key image is, for instance, a still image 51 having relevance to the key image with respect to, e.g. the date and time, person or location. The relevant image select module 233 selects the still images 51 relevant to the key image, for example, by using the index information 302A stored in the content information database 302. The relevant image select module 233 includes a date/time relevant image select module 233A, a person relevant image select module 233B and a location relevant image select module 233C.

The date/time relevant image select module 233A selects, from the still images 51 stored in the content database 301, still images 51 having the date and time of generation which is relevant to the date and time of generation of the key image. For example, based on the index information 302A, the date/time relevant image select module 233A selects still images 51 which are generated during the same period (the period designated by, e.g. a day, a month, a time of year, a season, or a year) as the date and time of generation of the key image. In addition, for example, based on the index information 302A, the date/time relevant image select module 233A selects still images 51 which are generated during the same day, the same week, the same month, etc. (e.g. the same day of the previous year, or the same month two years later) during a period different from the date and time of generation of the key image.

The person relevant image select module 233B selects still images 51 which are relevant to a key face image (a face image included in a key image), from the still images 51 stored in the content database 301. For example, the person relevant image select module 233B selects still images 51 including a face image of a person corresponding to the key face image. In addition, the person relevant image select module 233B selects still images 51 including a face image of a person resembling the person corresponding to the key face image. The face image of a person resembling the person corresponding to the key face image is selected, for example, by using a clustering result by the clustering module 222.

The person relevant image select module 233B selects still images 51 which are relevant to an event corresponding to a key image, from the still images 51 stored in the content database 301. The event is, for instance, an athletic meet, a family trip, etc. For example, based on the event ID of the index information 302A corresponding to the key image, the person relevant image select module 233B extracts a still image 51 having the same event ID as the key image, and selects another still image 51 in which the person appearing in this extracted still image 51 appears. Specifically, the person relevant image select module 233B extracts, for example, a photo which was taken in an “athletic meeting” that is the event corresponding to the key image, and selects another photo in which a child A appearing in this extracted photo appears.

Besides, for example, based on the event ID of the index information 302A corresponding to the key image, the person relevant image select module 233B extracts a still image 51 having the same event ID as the key image, and selects a still image 51 having an event ID corresponding to another still image 51 in which the person appearing in the extracted still image 51 appears. Specifically, the person relevant image select module 233B extracts, for example, photos which were taken in an “athletic meeting” that is the event corresponding to the key image. In addition, the person relevant image select module 233B detects another event in which a child A appearing in this extracted photos appears, and then extracts photos which belong to the another event.

In the meantime, when selecting the still images 51, the person relevant image select module 233B may preferentially select an image in which at least one of the smile degree, sharpness and frontality is high, or an image with a large size, by using the index information 302A.

The location relevant image select module 233C selects still images 51 which are generated at the location of generation that is relevant to the location of generation of the key image, from the still images 51 stored in the content database 301. For example, the location relevant image select module 233C selects, from the content database 301, still images 51 which are generated at the same location as the location of generation of the key image. Specifically, the location relevant image select module 233C selects, for example, another photo (still image 51) which was taken at a sightseeing spot at which the key image was generated, from the content database 301.

The location relevant image select module 233C may select a still image 51 which was generated at the same area as the area including the location of generation of the key image. Specifically, the location relevant image select module 233C selects, for example, a still image 51 which was generated in the country where the key image was generated, from the content database 301. To be more specific, the location relevant image select module 233C selects, for example, a photo which was taken in the same country as the key image but in a prefecture different from the prefecture where the key image was generated.

The relevant image select module 233 may further narrow down the still images 51, which are to be selected, by combining the selections of still images 51 by the date/time relevant image select module 233A, person relevant image select module 2338 and location relevant image select module 233C. In addition, the condition for selecting still images 51 may be changed according to where the moving picture to be generated is a photomovie or a slideshow.

The relevant image select module 233 (date/time relevant image select module 233A, person relevant image select module 233B and location relevant image select module 233C) outputs the information indicative of the selected still images 51 to the effect select module 234.

When the moving picture to be generated is a photomovie, the effect select module 234 selects an effect 303A, which is suited to the still image 51 selected by the relevant image select module 233, from the effects 303A stored in the effect database 303. In addition, the effect select module 234 selects audio (audio data) 303B which is suited to the still image 51 selected by the relevant image select module 233. The effect select module 234 selects the effect 303A and audio 303B, for example, based on the number of persons (the number of face images) appearing in the still images 51, the smile degree of the face images, etc.

In the meantime, the effect select module 234 may select scenario data 303C, which is suited to the still image 51 selected by the relevant image select module 233, from the scenario data 303C stored in the effect database 303. The scenario data 303C, as described above, include a plurality of chapters (time segments). In the scenario data 303C, the effects 303A, which are applied to the still images 51, are prescribed with respect to each chapter. Thus, by the selection of the scenario data 303C, the effects 303A which are used for the photomovie are selected in a lump.

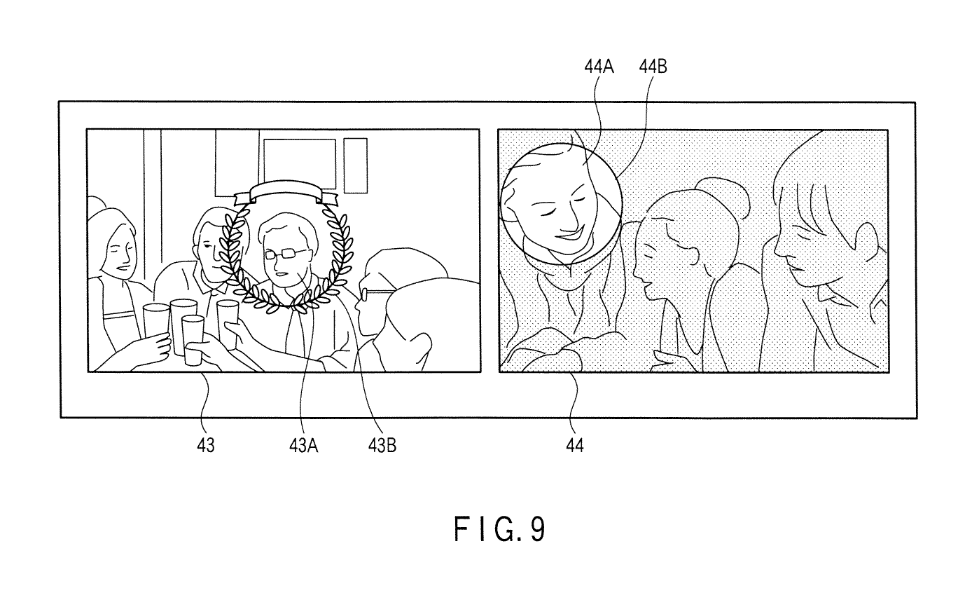

In the meantime, the effect select module 234 may select the effect 303A (scenario 303C) and audio 303B, which are designated by the user. In addition, when the moving picture is generated as a slideshow, the effect 303A, which applies a transition effect to the still image 51, may be selected from the effects 303A stored in the effect database 303. The effect select module 234 outputs to the moving picture generation module 235 the information indicative of the selected effect 303A (scenario 303C) and audio 303B and the information indicative of the still images 51 selected by the relevant image select module 233. Examples of the effects 303A will be described later with reference to FIGS. 9, 10 and 11.

The moving picture generation module 235 generates a photomovie or a slideshow by using the selected still images 51, effect 303A (scenario 303C) and audio 303B.

When the moving picture generated as the photomovie, the moving picture generation module 235 further selects still images 51, which satisfy the attribute prescribed by the effect 303A, from the still images 51 selected by the relevant image select module 233. Then, the moving picture generation module 235 generates the photomovie by using the selected still images 51 and the effect 303A and audio 303B selected by the effect select module 234. Specifically, for example, the moving picture generation module 235 generates the photomovie including the information indicative of the display timing of each still image 51, to which the effect 303A has been applied, the information indicative of the still images 51 (or face images included in the still images 51) to which each effect 303A is applied, and the information indicative of the output timing of the audio 303B.

When the moving picture is generated as the slideshow, the moving picture generation module 235 generates the slideshow by using the still images 51 selected by the relevant image select module 233. Specifically, for example, the moving picture generation module 235 generates the slideshow including the information indicative of the output timing of each of the still images 51 selected by the relevant image select module 233. In the meantime, the slideshow may include the information indicative of the display timing of each of the still images 51 to which the transition effect (effect 303A) has been applied, and the information indicative of the output timing of the audio 303B.

The moving picture generation module 235 outputs the generated photomovie or slideshow to the moving picture playback module 236.

The moving picture playback module 236 displays the photomovie or slideshow on the screen (LCD 17) by playing back the photomovie or slideshow which has been generated by the moving picture generation module 235. Specifically, when the photomovie is played back, the moving picture playback module 236 extracts, based on the information indicated in the photomovie, the still images 51 from the content database 301, and extracts the effect 303A and audio 303B from the effect database 303. Then, using the extracted still images 51, effect 303A and audio 303B, the moving picture playback module 236 plays back the photomovie. In the photomovie, the effect (effect 303A) is applied to at least either the still images 51 or the face images included in the still images 51. In addition, in the photomovie, the audio 303B is output in synchronized with the display of the still images 51 to which the effect has been applied (face images included in the still images 51 to which the effect has been applied).

When the slideshow is played back, the moving picture playback module 236 extracts the still images 51 from the content database 301, based on the information indicated in the slideshow. Using the extracted still images 51, the moving picture playback module 236 plays back the slideshow. In the slideshow, the selected still images 51 are successively displayed. In the slideshow, the moving picture playback module 236 may apply the effect 303A, such as a transition effect, to a change part between a still image 51 and a subsequent still image 51. The transition effect is selected from the effect database 303 by the effect select module 234.

In addition, as described above, the key image select module 231 may start the creation of the next photomovie by determining, for example, a still image 51, which is selected from the displayed photomovie (slideshow), to be a new key image.

By the above-described structure, the photomovie creation application 202 can present the moving picture including unexpected still images, etc. to the user. The relevant image select module 233 selects still images 51, which are relevant to a still image 51 (key image), from the still images 51 stored in the content database 301. The still images 51, which are relevant to the key image, are still images 51 which are associated with at least one of the date and time of generation of the key image, the location of generation of the key image and the person appearing in the key image. The photomovie creation application 202 selects not still images 51 satisfying a condition, such as the designated date and time of generation, but still images 51 having relevance to the key image. Thereby, still images, which the user is unaware of, can also be selected. When a moving picture is created by selecting still images which are grouped based on the date and time of generation, the location of generation, etc. (e.g. still images stored in a directory associated with each day of generation), only a moving picture using the still images belonging to the group can be created. However, in the photomovie creation application 202 of the embodiment, it is possible to select still images 51 which do not belong to the same group as the key image (based on the date and time of generation), but which have relevance to the key image. Thereby, it is possible to reduce the time which is consumed when the user selects still images 51, and to create the moving picture using the relevant still images 51.

FIG. 6 shows an example of a main screen 40 which is displayed by the playback control module 23 (moving picture playback module 236). The main screen 40 includes, for example, a “style” button 401, a “music” button 402, a “main character” button 403, a “start” button 404, a movie playback screen 405, and a “calendar” button 406.

The movie playback screen 405 is a screen for displaying a generated photomovie or slideshow. On the movie playback screen 405, the photomovie or slideshow, which is generated by the playback control module 23 (moving picture generation module 235), is successively played back and displayed. The movie playback screen 405 displays an image in which persons 40A to 40F, for example, appear.

On the movie playback screen 405, for example, when an operation of clicking an image which is being displayed is detected, the key image select module 231 determines this image to be the key image. If the image which is being played back is an image which is generated by combining a plurality of still images, the photomovie creation application 202 may determine one of these still images to be the key image. Needless to say, one of the still images, which has been clicked by the user, may be determined to be the key image. In addition, when an operation of clicking an image, which is displayed on the movie playback screen 405, has been detected, the moving picture playback module 236 may keep the selected key image in the displayed state by pausing playback of the photomovie (slideshow).

The “main character” button 403 is a button for starting the selection of a person of interest (key face image) in the generated photomovie. Responding to the pressing of the “main character” button 403, the key image select module 231 displays a list of persons appearing in the key image (face image select screen). For example, after selecting the key image by using the movie playback screen 405, the user instructs the start of the selection of the key face image (i.e. the display of the face image select screen) by pressing the “main character” button 403.

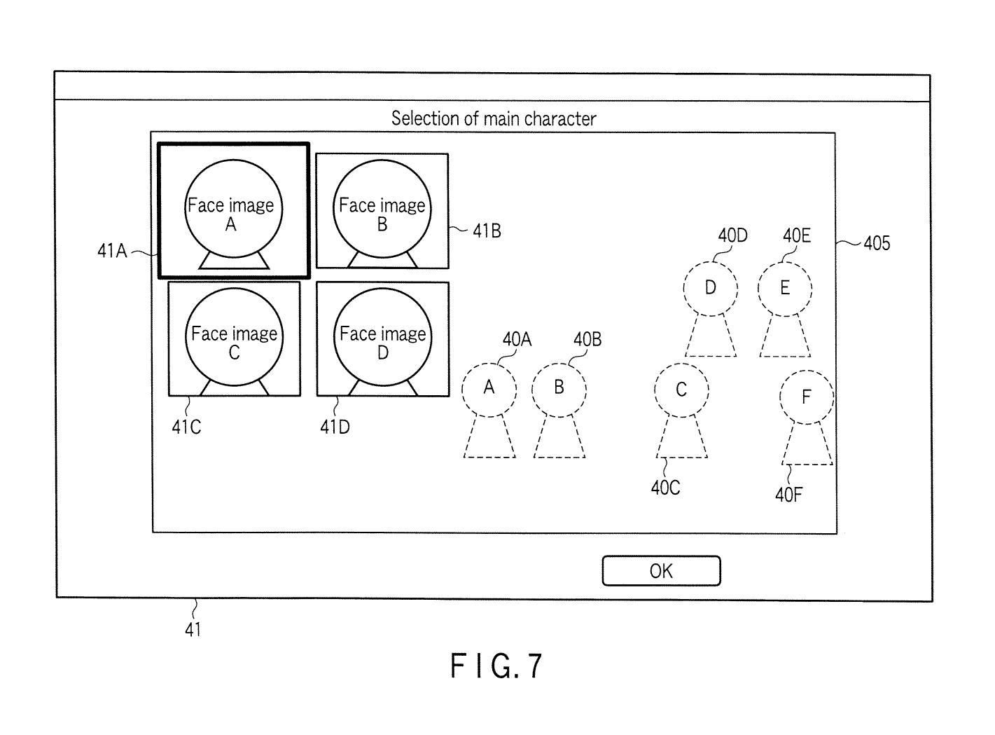

FIG. 7 shows an example of a face image select screen 41 for selecting a key face image. The face image select screen 41 displays a list of face images (face images 41A to 41D) included in a key image. The key image select module 231 displays, for example, face images of persons whose appearance frequency is a threshold value or more from among the persons 40A to 40F appearing in the key image on the face image select screen 41. The face images of persons whose appearance frequency (the number of still images in which the person appears) is the threshold value or more are e.g. face images 41A to 41D of persons 40A to 40D.

Using the face image select screen 41, the user selects the face image (face image 41A in this example) of the person of interest from among the face images 41A to 41D. The key image select module 231 determines the selected face image to be the key face image. The number of face images to be selected may be plural. When an operation of selecting a face image with use of the face image select screen 41 is not performed (e.g. when the “main character” button 403 is not pressed), the key image select module 231 may determine a face image to be the key face image by selecting the face image, which satisfies a predetermined condition, from among the face images included in the key image.

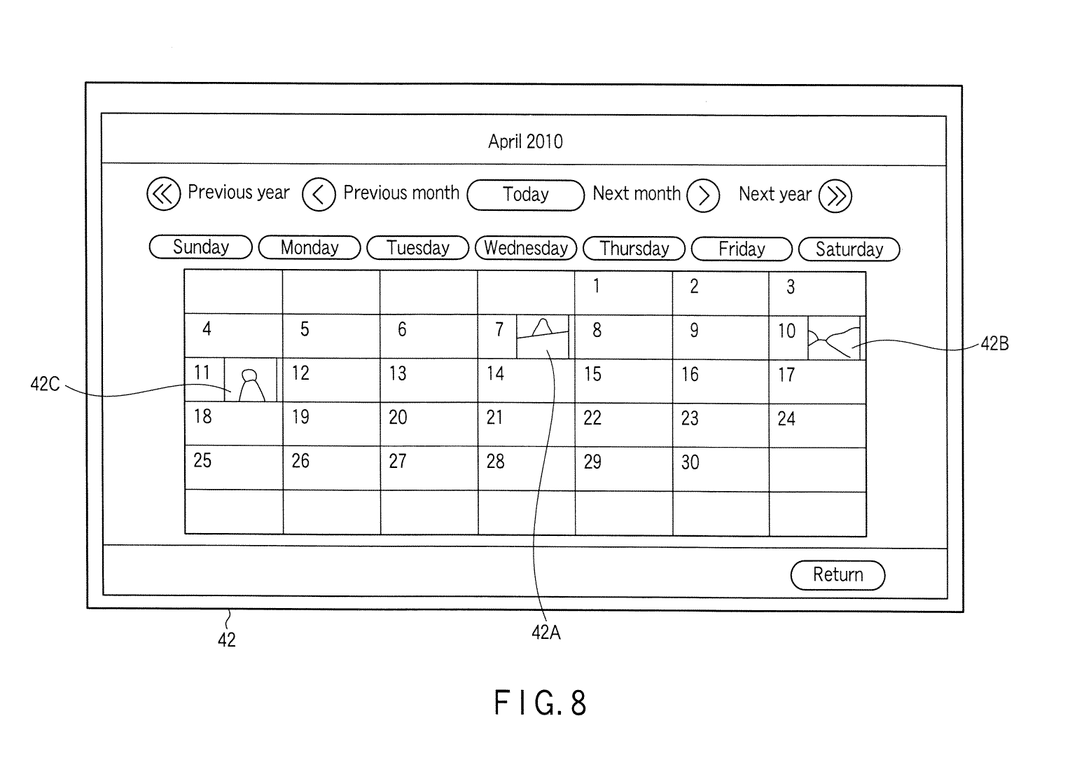

The “calendar” button 406 on the main screen 40 of FIG. 6 is a button for displaying a calendar screen 42. FIG. 8 shows an example of the calendar screen 42. As described above, the key image select module 231 may select a key image by using the calendar screen 42 in which still images 51 are arranged on a calendar. The calendar screen 42 displays, for example, a calendar of a designated month, and displays thumbnail images 42A, 42B and 42C of still images 51 in the fields of days on the calendar. The key image select module 231 determines the still image 51, which corresponds to the thumbnail image selected by using the calendar screen 42, to be the key image.

When there are still images 51 having the same date of generation, the thumbnail image of any of the still images 51 is displayed on the calendar screen 42 as a representative image. When the representative image is selected by using the calendar screen 42, the key image select module 231 displays the list of thumbnail images of the still images 51 which were generated on the corresponding date. The key image select module 231 determines the still image 51, which corresponds to the thumbnail image selected from the list, to be the key image. The key image select module 231 can also select a key face image by using the above-described face image select screen 41, when the key image has been selected by using the calendar screen 42.

The “style” button 401 is a button for starting selection of a style (scenario 303C) which is used for a photomovie. Responding to the pressing of the “style” button 401, the playback control module 23 displays a list of scenarios 303C (style select screen). The effect select module 234 determines, for example, a scenario 303C, which has been selected by the user with use of the style select screen, to be the scenario 303C that is used for the photomovie. The relevant image select module 233 may select (extract), from the still images 51 stored in the content database 301, still images satisfying either or both of the conditions of one or more still images (still images) relevant to the key image (key face image) and one or more still images (still images) corresponding to the style (scenario 303C) selected by using the style select screen.

The “music” button 402 is a button for starting the selection of the audio (audio data) 303B which is used for the photomovie. Responding to the pressing of the “music” button 402, the playback control module 23 displays the list of audio 303B (music select screen). The effect select module 234 determines, for example, audio 303B, which has been selected by the user with use of the music select screen, to be the audio 303B which is used for the photomovie.

The “start” button 404 is a button for starting generation and playback of the photomovie. Responding to the pressing of the “start” button 404, the moving picture generation module 235 starts the creation of the photomovie. Then, the moving picture playback module 236 displays the created photomovie on the movie playback screen 405 by playing back the photomovie.

The user performs an operation for creating the photomovie by using the above-described main screen 40, face image select screen 41 and calendar screen 42. While no operation is performed by the user, the photomovie creation application 202 may automatically determine the key image which satisfies a predetermined condition. In this case, still images 51 relevant to the determined key image are selected, and a slideshow (photomovie) using the still images 51 is played back. In short, for example, when an operation is performed by the user, the photomovie corresponding to this operation is played back, and when no operation is performed by the user, a slideshow which is generated based on a predetermined condition is played back.

FIGS. 9, 10 and 11 show examples of the screen (photomovie) including still images 51 to which the effect 303A has been applied. FIG. 9 shows an example in which an effect is applied to a face image of a person appearing in a still image. On a screen 43, an effect 43B for emphasizing a person 43A is applied to the face image of the person 43A. The effect 43B superimposes an illustration, which surrounds the face image, on the face image. On a screen 44, an effect 44B, which puts a spot on a person 44A, is applied to the face image of the person 44A. The effect 44B darkens the region other than the face image of the person 44A.

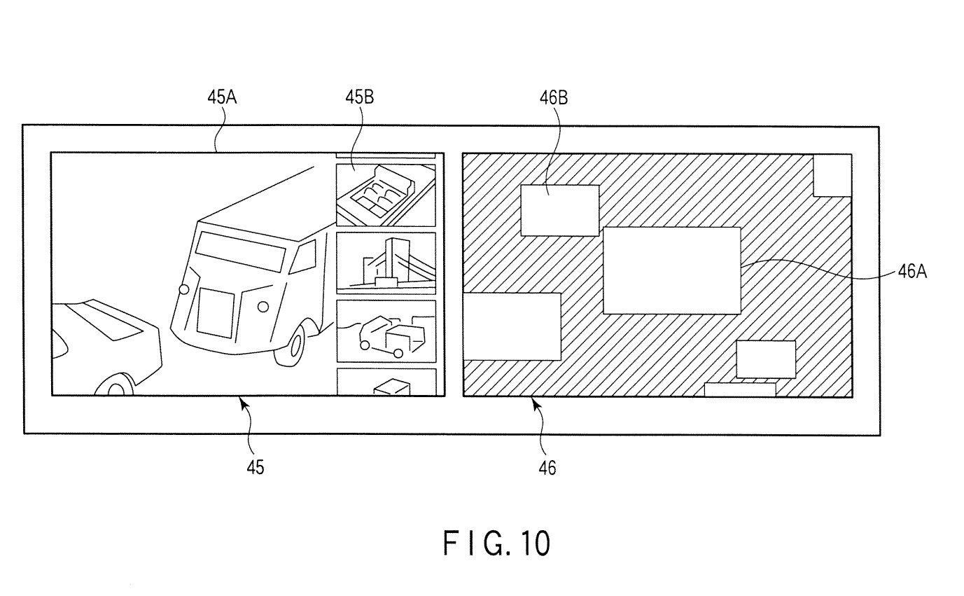

FIG. 10 shows an example in which an effect is applied to a plurality of still images. On a screen 45 and a screen 46, an effect is applied to the still images in order to display the still images which are combined. This effect determines the arrangement, sizes and motions of the still images.

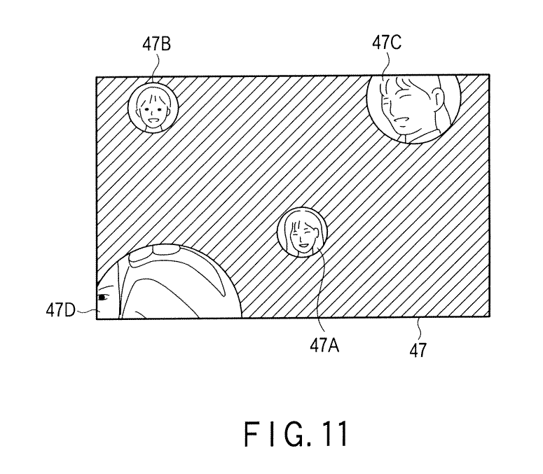

FIG. 11 shows an example in which an effect is applied to the face images of persons appearing in each of still images. On a screen 47, face images 47A to 47D, which are clipped out of still images, are displayed. To the face images 47A to 47D, an effect is applied such that the respective face images move on the screen 47. The effects 303A are not limited to the examples of FIGS. 9, 10 and 11. The effects 303A may include various effects for applying decorative effects to still images 51, such as zoom, rotation, slide-in/slide-out, a superimposition effect of an image such as a frame, and fade-in/fade-out.

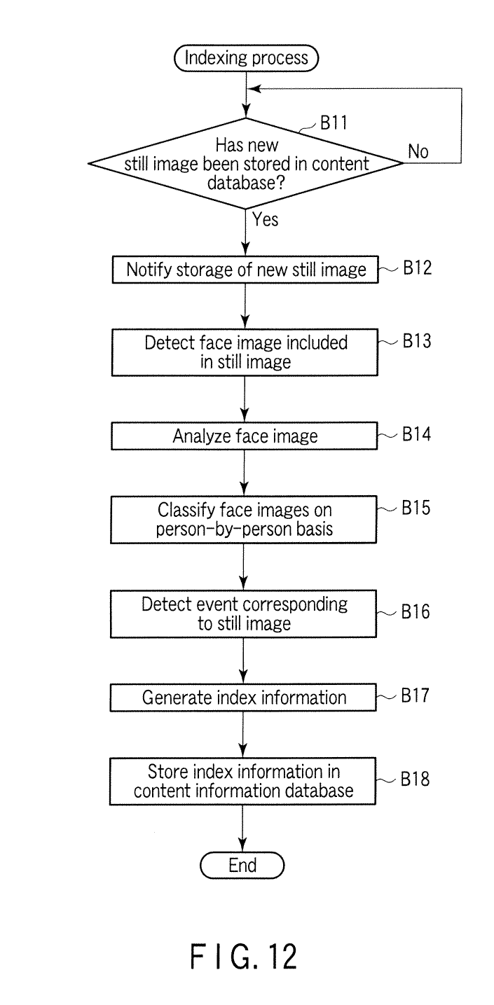

Next, referring to a flowchart of FIG. 12, a description is given of an example of the procedure of the indexing process which is executed by the photomovie creation program 202.

To start with, the monitoring module 21 determines whether a new still image (still image data) 51 has been stored in the content database 301 in the HDD 109 by constantly monitoring the content database 301 (block B11). If no new still image is stored (NO in block B11), the monitoring module 21 determines once again whether a new still image 51 has been stored by returning to block B11.

If a new still image 51 is stored (YES in block B11), the monitoring module 21 notifies the indexing module 22 that the new still image 51 has been stored in the content database 301 (block B12).

Then, the face image detection module 221 detects a face image (face images) included in the still image 51 (block B13). The face image detection module 221 detects a region corresponding to the face image of a person appearing in the still image 51, and then detects the position and size of the region in the still image. The face image detection module 221 analyzes the detected face image (block B14). The face image detection module 221 calculates, for example, the smile degree, sharpness, frontality, etc. of the detected face image. The face image detection module 221 outputs the information indicative of the detected face image to the clustering module 222.

The clustering module 222 classifies the detected face image on a person-by-person basis by subjecting the detected face image to a clustering process (block B15). The clustering module 222 allocates the identification information (person ID) of the corresponding person to the face image. The clustering module 222 outputs to the index information generation module 224 the information indicative of the face image detected by the face image detection module 221 and the information indicative of the person ID allocated to the face image.

The event detection module 223 detects an event corresponding to the still image 51 (block B16). The event detection module 223 allocates the identification information (event ID) of the classified event to the still images 51. The event detection module 223 outputs the event ID, which has been allocated to the still image 51, to the index information generation module 224.

The index information generation module 224 generates the index information 302A, based on the processing results by the face image detection module 221 and clustering module 222 (block B17). The index information 302A includes the date and time of generation of the still image 51, the location of generation of the still image 51, the event ID of the still image 51, and the face image information indicative of the face image included in the still image 51. The face image information includes, for example, a face image (e.g. the storage location of data corresponding to the face image), person ID, position, size, smile degree, sharpness, and frontality. When a plurality of face images are included in the still image 51, the index information 302A includes a plurality of face image information items corresponding to the respective face images. The index information generation module 224 stores the generated index information 302A in the content information database 302 (block B18).

By the above-described process, the index information 302A (the entry of index information 302A) corresponding to the still image 51, which has newly been stored in the content database 301, is stored in the content information database 302.

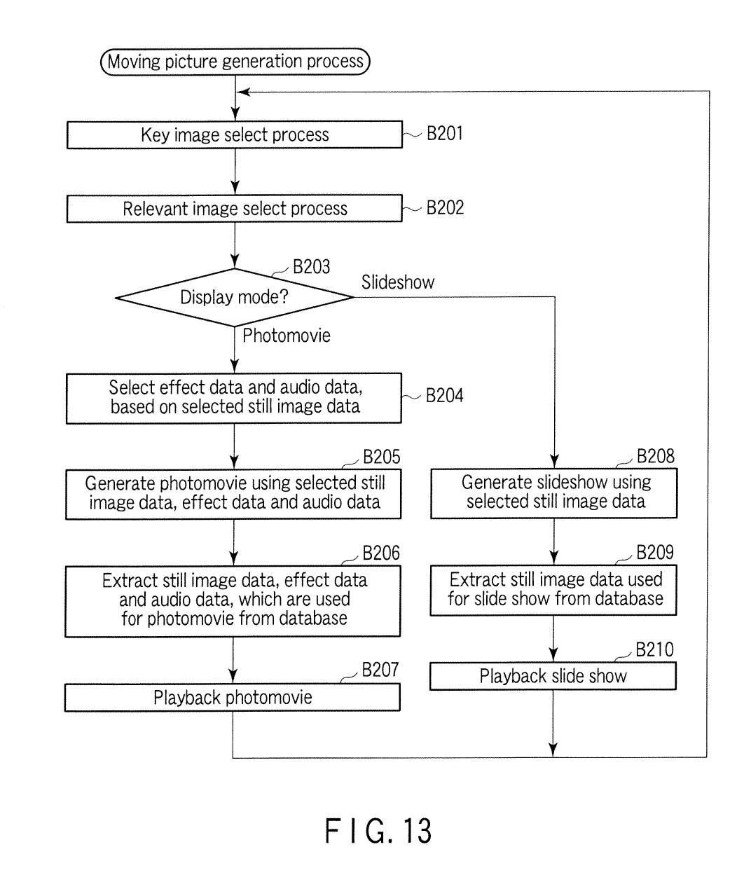

Next, referring to a flowchart of FIG. 13, a description is given of an example of the procedure of the moving picture generation process which is executed by the photomovie creation application program 202. The photomovie creation application program 202 plays back a moving picture of either a photomovie or a slideshow.

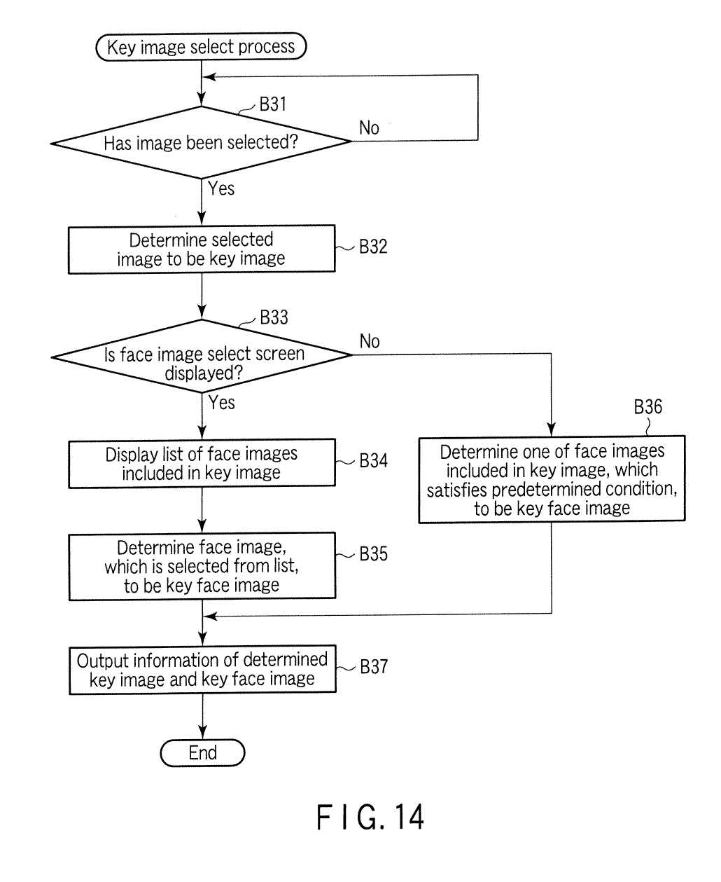

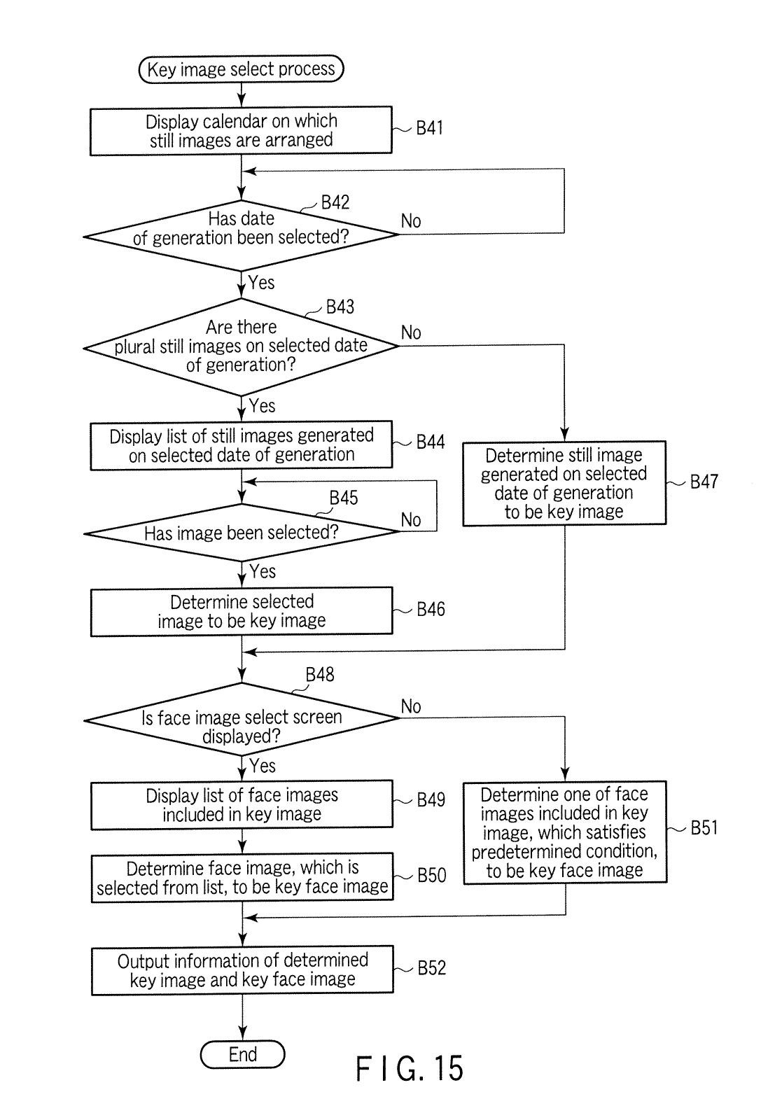

To start with, the key image select module 231 executes a key image select process (block B201). The key image select module 231 selects a key image from the still images 51 stored in the content database 301. The key image is used as an extraction key for extracting, from the content database 301, still images 51 which are used for a moving picture (photomovie or slideshow) that is to be played back. The key image select module 231 outputs the information indicative of the selected key image to the relevant image select module 233. The details of the procedure of the key image select process will be described later with reference to FIGS. 14 and 15.

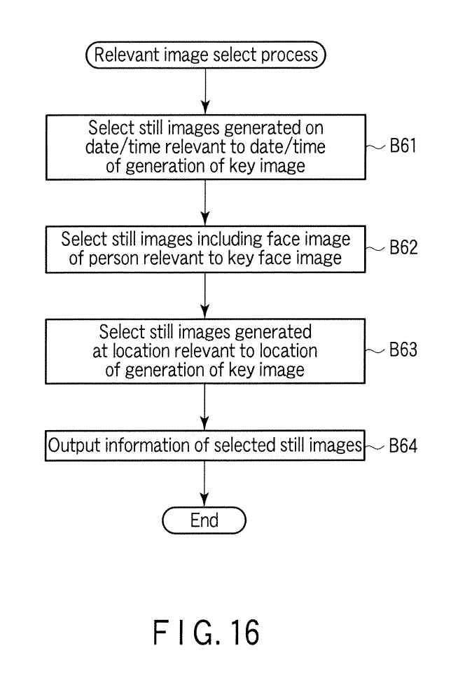

The relevant image select module 233 executes a relevant image select process by using the key image selected by the key image select module 231 (block B202). The relevant image select module 233 selects still images 51, which are relevant to the key image, from the content database 301. The still image 51 relevant to the key image is, for instance, a still image 51 having relevance to the key image with respect to at least one of the date and time, person and location. The relevant image select module 233 outputs to the effect select module 234 the information indicative of the still image 51 relevant to the selected key image. The details of the procedure of the relevant image select process will be described later with reference to FIG. 16.

The effect select module 234 determines whether the display mode is a photomovie mode or a slideshow mode (block B203). The display mode indicates whether the moving picture to be played back is a photomovie or a slideshow. The display mode may be changed by the user. In addition, a moving picture corresponding to a preset display mode may be played back, or the display mode may be switched based on a predetermined condition.

When the display mode is determined to be the photomovie (“Photomovie” in block B203), the effect select module 234 selects the effect 303A and audio 303B, based on the still image 51 selected by the relevant image select module 233 (block B204). The effect select module 234 selects the effect 303A and audio 303B which are suited to the selected still image 51. The effect select module 234 outputs the selected still image 51 and the information indicative of the effect 303A and audio 303B to the moving picture generation module 235.

The moving picture generation module 235 creates a photomovie by using the still images 51 selected by the relevant image select module 233 and the effect 303A (scenario data 303C) and audio 303B which are selected by the effect select module 234 (block B205). The moving picture generation module 235 outputs the generated photomovie to the moving picture playback module 236.

The moving picture playback module 236 extracts, based on the photomovie generated by the moving picture generation module 235, the still images 51 which are used for the photomovie from the content database 301, and extracts the effect 303A and audio 303B which are used for the photomovie from the effect database 303 (block B206). Then, using the extracted still images 51, effect 303A and audio 303B, the moving picture playback module 236 displays the photomovie on the screen (LCD 17) by playing back the photomovie (block B207). Subsequently, the key image select module 231 determines, for example, a still image 51, which is selected from the displayed photomovie, to be a new key image by returning to the key image select process of block B201.

On the other hand, when the display mode is determined to be the slideshow (“Slideshow” in block B203), the moving picture generation module 235 creates a slideshow by using the still images 51 which are selected by the relevant image select module 233 (block B208). The moving picture generation module 235 outputs the generated slideshow to the moving picture playback module 236.

The moving picture playback module 236 extracts the still images 51 which are used for the slideshow from the content database 301 based on the slideshow generated by the moving picture generation module 235 (block B209). Then, the moving picture playback module 236 displays the slideshow on the screen (LCD 17) by playing back the slideshow using the extracted still images 51 (block B210). In the slideshow, the extracted still images 51 are successively displayed at a predetermined timing. Then, the key image select module 231 determines, for example, a still image 51, which is selected from the slideshow, to be a new key image by returning to the key image select process of block B201.

By the above-described process, the photomovie creation application program 202 can display the slideshow or photomovie using the still images 51 relevant to the key image. By using the still images 51 relevant to the key image, a moving picture including unexpected still images, etc. can be presented to the user.

A flowchart of FIG. 14 illustrates an example of the procedure of the key image select process (block B201 in FIG. 13) which is executed by the key image select module 231. It is assumed that a key image is selected from the moving picture (photomovie or slideshow) which is displayed on the screen.

To start with, the key image select module 231 determines whether an image has been selected from the moving picture which is being displayed (block B31). When the key image select module 231 has detected, for example, an operation of clicking an image which is being displayed on the screen, the key image select module 231 determines that this image has been selected as the key image. When no image is selected (NO in block B31), the key image select module 231 determines once again whether an image has been selected by returning to the process of block B31. When an image has been selected (YES in block B31), the key image select module 231 determines the selected image to be the key image (block B32).

Then, the key image select module 231 determines whether the face image select screen 41 is to be displayed or not (block B33). For example, when a button for instructing the display of the face image select screen 41 has been pressed, the key image select module 231 determines that the face image select screen 41 is to be displayed. For example, when a button for finalizing the key image has been pressed, the key image select module 231 determines that the face image select screen 41 is not to be displayed.

When the face image select screen 41 is to be displayed (YES in block B33), the key image select module 231 displays the face image select screen 41 (block B34). The face image select screen 41 is a screen which displays, for example, a list of face images included in the determined key image. The user performs an operation of selecting a face image of a person of interest (main character) from the displayed list of face images. The key image select module 231 determines the face image, which has been selected from the face image select screen 41 (list of face images), to be the key face image (block B35). In the meantime, a plurality of face images may be selected by using the face image select screen 41.

When the face image select screen 41 is not to be displayed (NO in block B33), the key image select module 231 determines that one of the face images included in the key image, which satisfies a predetermined condition, to be the key face image (block B36). For example, the key image select module 231 may determine that one of the face images included in the key image, which satisfies a condition based on the position, size, sharpness, etc. of the face image, to be the key face image.

After determining the key face image in block B35 or block B36, the key image select module 231 outputs the information indicative of the determined key image and key face image to the relevant image select module 233 (block B37).

By the above-described process, the key image select module 231 can determine the key image and key face image for extracting still images 51, by using the moving picture (photomovie or slideshow) which is being played back and the face image select screen 41. Based on the determined key image and key face image, the relevant image select module 233 selects still images 51 relevant to the key image and key face image, from among the still images 51 stored in the content database 301.

A flowchart of FIG. 15 illustrates another example of the procedure of the key image select process (block B201 in FIG. 13) which is executed by the key image select module 231. It is assumed that a key image is selected by using the calendar screen 42.

To start with, the calendar display module 232 displays the calendar screen 42 on which still images 51 are arranged based on the date and time of generation (block B41). The calendar display module 232 displays a thumbnail image of the still image 51 having the corresponding date of generation, for example, in each of the fields of days provided on the calendar screen 42. When there are a plurality of still images 51 having the same date of generation, the calendar display module 232 displays the thumbnail image (representative thumbnail image) of a still image 51 selected from the still images 51. The user selects one of the dates of generation, which correspond to the fields displaying the thumbnail images, by using the calendar screen 42.

Next, the calendar display module 232 determines whether the date of generation has been selected (block B42). For example, when the calendar display module 232 detects that one of the fields of days on the calendar screen 42 has been clicked, the calendar display module 232 determines that the date of generation has been selected. When the date of generation is not selected (NO in block B42), the calendar display module 232 determines once again whether the date of generation has been selected by returning to the process of block B42.

When the date of generation is selected (YES in block B42), the calendar display module 232 determines whether there are a plurality of still images 51 which are generated on the selected date of generation (block B43). When there are a plurality of still images 51 generated on the selected date of generation (YES in block B43), the calendar display module 232 displays a list of thumbnail images corresponding to the respective still images 51 on the screen (block B44). Then, the calendar display module 232 determines whether an image has been selected from the displayed list (block B45). If no image is selected from the list (NO in block B45), the calendar display module 232 determines once again whether an image is selected from the list by returning to block B45. If an image is selected from the list (YES in block B45), the key image select module 231 determines the selected image to be the key image (block B46).

When a plurality of still images 51 generated on the selected date of generation are not present (i.e. when there is one still image 51 generated on the selected date of generation) (NO in block B43), the calendar display module 232 determines the still image 51 generated on the selected date of generation to be the key image (block B47).

After the key image is determined in block B46 or block B47, the key image select module 231 determines whether the face image select screen 41 is to be displayed or not (block B48). For example, when a button for instructing the display of the face image select screen 41 has been pressed, the key image select module 231 determines that the face image select screen 41 is to be displayed. For example, when a button for finalizing the key image has been pressed, the key image select module 231 determines that the face image select screen 41 is not to be displayed.

When it is determined that the face image select screen 41 is to be displayed (YES in block B48), the key image select module 231 displays the face image select screen 41 (block B49). The face image select screen 41 is a screen which displays, for example, a list of face images included in the determined key image. The user performs an operation of selecting a face image of a person of interest (main character) from the displayed list of face images. The key image select module 231 determines the face image, which has been selected from the face image select screen 41 (list of face images), to be the key face image (block B50). In the meantime, a plurality of face images may be selected by using the face image select screen 41.

When the face image select screen 41 is not to be displayed (NO in block B48), the key image select module 231 determines that one of the face images included in the key image, which satisfies a predetermined condition, to be the key face image (block B51). For example, the key image select module 231 may determine that one of the face images included in the key image, which satisfies a condition based on the position, size, sharpness, etc. of the face image, to be the key face image.

After determining the key face image in block B50 or block B51, the key image select module 231 outputs the information indicative of the determined key image and key face image to the relevant image select module 233 (block B52).

By the above-described process, the key image select module 231 can determine the key image and key face image for extracting still images 51, by using the calendar screen 42 and face image select screen 41. Based on the determined key image and key face image, the relevant image select module 233 selects still images 51 relevant to the key image and key face image, from among the still images 51 stored in the content database 301. In the meantime, the selection of the key image is not limited to the above-described processes of selecting the key image from the moving picture that is being displayed or from the calendar screen 42. For example, the key image may be selected from the list indicative of the still images 51 stored in the content database 301.

Next, referring to a flowchart of FIG. 16, a description is given of an example of the procedure of the relevant image select process (block B202 in FIG. 13) which is executed by the relevant image select module 233.

To start with, the date/time relevant image select module 233A selects still images 51 having the generated date and time, which is relevant to the generated date and time of the key image, from the still images 51 stored in the content database 301 (block B61). Next, the person relevant image select module 233B selects still images 51 which are relevant to a key face image, from the still images 51 stored in the content database 301 (block B62). For example, the person relevant image select module 233B selects, from the still images stored in the content database 301, a still image 51 including a face image of a person appearing in the key face image, a still image 51 in which another person relevant to this person appears, and another still image 51 of an event (event group) to which the key image belongs. The location relevant image select module 233C selects still images 51 having the generated location, which is relevant to the generated location of the key image, from the still images 51 stored in the content database 301 (block B63).

The relevant image select module 233 outputs the information indicative of the still images 51, which have been selected by the date/time relevant image select module 233A, person relevant image select module 233B and location relevant image select module 233C, to the effect select module 234 (block B64). In the meantime, based on the still images 51 selected by the date/time relevant image select module 233A, person relevant image select module 233B and location relevant image select module 233C, the relevant image select module 233 may further narrow down the still images 51 which are to be selected. In addition, the relevant image select module 233 may extract images which satisfy both the condition of image extraction according to the style and the condition that such images are relevant to the key image.

By the above-described process, the relevant image select module 233 selects the still images 51 relevant to the key image or key face image. Using the selected still images 51, the moving picture generation module 235 generates the moving picture (photomovie or slideshow).

As has been described above, according to the present embodiment, a moving picture including unexpected still images can be presented to the user. The photomovie creation application program 202 can display a slideshow or a photomovie using the still images 51 relevant to a key image by selecting the key image. By using the still images 51 relevant to the key image, the moving picture including unexpected still images can be presented to the user. Moreover, since the user can create a photomovie including the still images 51 relevant to the key image simply by performing an operation of designating the key image, the time consumed in the photomovie creation can be reduced.

All the procedures of the image display process in this embodiment may be executed by software. Thus, the same advantageous effects as with the present embodiment can easily be obtained simply by installing a program, which executes the procedures of the image display process, into an ordinary computer through a computer-readable storage medium which stores the program, and executing this program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
an indexing module configured to generate index information of a plurality of still images;
an image select module configured to select a still image from the plurality of still images;
an image extraction module configured to extract still images which are relevant to the selected still image from the plurality of still images by using the index information; and
an image display module configured to display a moving picture using the extracted still images.

2. The electronic apparatus of claim 1, wherein the selected still image is a still image selected from the still images used for the moving picture displayed by the image display module.

3. The electronic apparatus of claim 1, wherein the index information comprises information indicative of a date and time of generation of each of the plurality of still images,
the electronic apparatus further comprises a calendar display module configured to display the plurality of still images by arranging the plurality of still images in an order of the date and time of generation on a screen, and
the selected still image is a still image selected from the plurality of still images displayed by the calendar display module.

4. The electronic apparatus of claim 1, wherein the indexing module is configured to detect face images included in the plurality of still images, to classify the detected face images on a person-by-person basis, and to generate the index information including information of the face images, and
the extracted still images relevant to the selected still image comprise a still image including a face image of a person identical to a person corresponding to a face image included in the selected still image.

5. The electronic apparatus of claim 4, further comprising a face image select module configured to select, when the selected still image includes a plurality of face images, one or more face images from the plurality of face images based on the index information, and
the extracted still images relevant to the selected still image comprise a still image including a face image of a person identical to a person corresponding to the one or more face images.

6. The electronic apparatus of claim 4, wherein the image display module is configured to display a moving picture using at least either the extracted still images to which an effect is applied, or face images included in the extracted still images to which an effect is applied.

7. The electronic apparatus of claim 1, wherein the index information comprises information indicative of a date and time of generation of each of the plurality of still images, and
the extracted still images relevant to the selected still image comprise at least either a still image generated during a predetermined period including a date and time of generation of the selected still image, or a still image generated on a date and time relevant to the date and time of generation of the selected still image.

8. The electronic apparatus of claim 1, wherein the index information comprises information indicative of a location of generation of each of the plurality of still images, and
the extracted still images relevant to the selected still image comprise at least either a still image generated at a location of generation of the selected still image, or a still image generated at a location relevant to the location of generation of the selected still image.

9. The electronic apparatus of claim 1, wherein the index information comprises information indicative of an event in which each of the plurality of still images is generated, and
the extracted still images relevant to the selected still image comprise at least either a still image generated in an event in which the selected still image is generated, or a still image generated in an event relevant to the event in which the selected still image is generated.

10. The electronic apparatus of claim 1, wherein the image display module is configured to display a moving picture using the extracted still images to which an effect is applied.

11. An image processing method comprising:
generating index information of a plurality of still images;
selecting a still image from the plurality of still images;
extracting still images which are relevant to the selected still image from the plurality of still images by using the index information; and
displaying a moving picture using the extracted still images.
